(19) United States
(12) Patent Application Publication
(10) Pub. No.: US 2026/0175386 A1
(43) Pub. Date: Jun. 25, 2026

(54) RETRIEVING DEVICE AND ELECTRIC NAIL GUN HAVING THE SAME

(71) Applicant: BASSO INDUSTRY CORP., Taichung (TW)

(72) Inventor: Chia-Yu CHIEN, Taichung (TW)

(73) Assignee: BASSO INDUSTRY CORP., Taichung (TW)

(21) Appl. No.: 19/427,002

(22) Filed: Dec. 19, 2025

(30) Foreign Application Priority Data
Dec. 23, 2024 (TW) 113214133

(51) Int. Cl. B25C 1/06

(52) U.S. Cl. CPC B25C 1/06

(57) ABSTRACT

A retrieving device includes at least one first position member that is adapted to be connected to a swing arm unit, at least one second position member that is adapted to be connected to a nail-striking unit, that is sleeved on the at least one first position member, and that is slidable relative to the at least one first position member in a nail-striking direction and a retrieving direction opposite to the nail-striking direction, and at least one resilient member. The at least one second position member is constantly in contact with the at least one first position member. The at least one resilient member is operable for generating a resilient force to move the at least one second position member in the retrieving direction so as to retrieve the nail-striking unit in the retrieving direction.

### CROSS-REFERENCE TO RELATED APPLICATION

This application claims priority to Taiwanese Utility Model Patent Application No. 113214133, filed on Dec. 23, 2024, the entire disclosure of which is incorporated by reference herein.

### FIELD

The disclosure relates to a retrieving device, and more particularly to a retrieving device and an electric nail gun having the same.

### BACKGROUND

A conventional electric nail gun as disclosed in Taiwanese Invention Patent No. I830981 includes a swing arm unit that is pivotably mounted to a frame, and that is pivotable relative to a flywheel, a nail-striking unit that is movably connected to the swing arm unit, a position unit, and a retrieving unit. During pivot movement of the swing arm unit, the nail-striking unit abuts against the flywheel to thereby be driven by the flywheel to move and strike a nail. The position unit includes two first position members that are fixed to the swing arm unit, and two second position members that are fixed to the nail-striking unit. The retrieving unit includes two resilient members. Each of the resilient members interconnects a respective one of the first position members and a respective one of the second position members, such that the nail-striking unit is driven by the resilient force of the resilient members to move backwards after striking the nail.

However, referring to FIG. 6 of Taiwanese Invention Patent No. I830981, during a nail-striking process of the conventional electric nail gun, the first position members and the second position members break contact with each other. At this time, since the first position members and the second position members are separated from each other, the structure of each of the resilient members is not fully supported and is unstable. Hence, there is room for improvement.

### SUMMARY

Therefore, an object of the disclosure is to provide a retrieving device and an electric nail gun that can alleviate at least one of the drawbacks of the prior art.

According to one aspect of the disclosure, the retrieving device is adapted to be mounted to an electric nail gun. The electric nail gun includes a gun body, a flywheel that is mounted in the gun body and that is driven rotatably by electrical energy, a swing arm unit that is mounted to the gun body and that is pivotable relative to the flywheel, and a nail-striking unit that is movably connected to the swing arm unit. The nail-striking unit is co-movable with the swing arm unit to abut against the flywheel during pivot movement of the swing arm unit, thereby being driven by the flywheel to move in a nail-striking direction relative to the swing arm unit. The retrieving device includes at least one first position member, at least one second position member, and at least one resilient member. The at least one first position member is adapted to be connected to the swing arm unit. The at least one second position member is adapted to be connected to the nail-striking unit, extends in a retrieving direction opposite to the nail-striking direction, is sleeved on the at least one first position member, and is slidable relative to the at least one first position member in the nail-striking direction and the retrieving direction. The at least one second position member is constantly in contact with the at least one first position member. The at least one resilient member interconnects the at least one first position member and the least one second position member, and is operable for generating a resilient force to move the at least one second position member in the retrieving direction so as to retrieve the nail-striking unit in the retrieving direction.

Another aspect of the disclosure is to provide an electric nail gun that includes a gun body, a flywheel, a swing arm unit, a nail-striking unit, and the abovementioned retrieving device. The flywheel is mounted in the gun body and is driven rotatably by kinetic energy. The swing arm unit is mounted to the gun body and is pivotable relative to the flywheel. The nail-striking unit is movably connected to the swing arm unit. The nail-striking unit is co-movable with the swing arm unit to abut against the flywheel during pivot movement of the swing arm unit, thereby being driven by the flywheel to move in a nail-striking direction relative to the swing arm unit. The retrieving device is connected to the swing arm unit and the nail-striking unit.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a sectional view illustrating an embodiment of an electric nail gun according to the disclosure.

FIG. 2 is an exploded perspective view illustrating a swing arm unit, a nail-striking unit, and a retrieving device of the embodiment.

FIG. 3 is a fragmentary perspective view of the embodiment.

FIG. 4 is a fragmentary sectional view of the embodiment, illustrating the nail-striking unit at a pre-striking position, and the swing arm unit at a normal position.

FIG. 5 is a fragmentary sectional view similar to FIG. 4, but the swing arm unit is at a biased position.

FIG. 6 is a fragmentary sectional view of the embodiment taken along line VI-VI in FIG. 5.

FIG. 7 is a fragmentary sectional view of the embodiment, illustrating the nail-striking unit at a post-striking position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

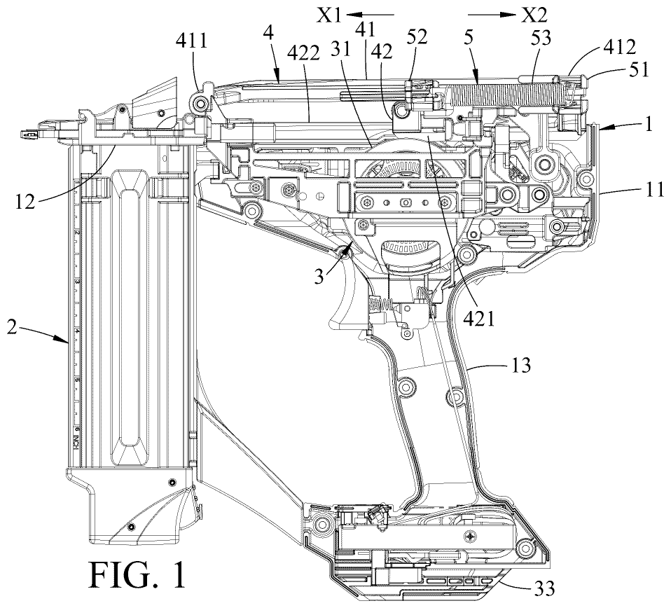

Referring to FIGS. 1 to 4, an embodiment of an electric nail gun according to the disclosure includes a gun body 1, a magazine device 2, an actuation device 3, a nail-striking device 4, and a retrieving device 5.

The gun body 1 has a main body portion 11, a barrel 12 that is connected to the main body portion 11, and a grip portion 13 that is connected to the main body portion 11, and that is for a user to grip.

The magazine device 2 is connected to the barrel 12, and is adapted for accommodating a plurality of nails (not shown), and for conveying the nails one by one into the barrel 12. For the sake of brevity, only one of the nails will be mentioned in the following description.

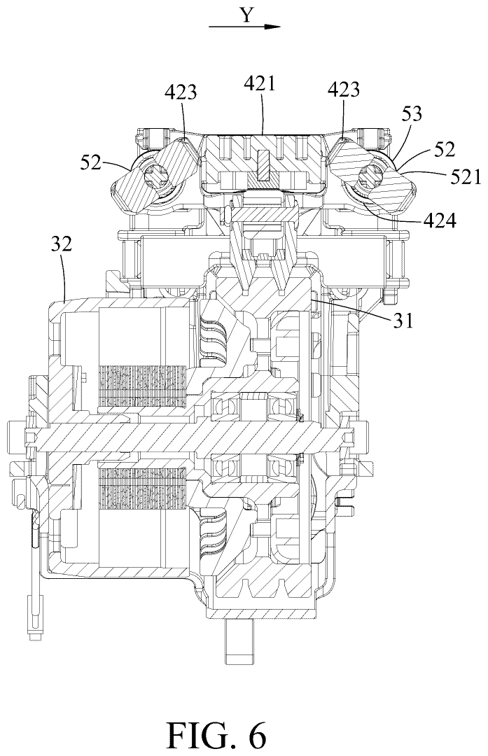

Referring further to FIG. 6, the actuation device 3 includes a flywheel 31 that is rotatably mounted to the main body portion 11, a motor 32 that is mounted to the main body portion 11, and a battery unit 33 (see FIG. 1) for providing electrical energy to the motor 32. The flywheel 31 is driven rotatably by kinetic energy. Specifically, the motor 32 is for converting electrical energy to kinetic energy, and the kinetic energy is transmitted to other components of the embodiment through the flywheel 31.

The nail-striking device 4 includes a swing arm unit 41 that is mounted to the gun body 1 and that is pivotable relative to the flywheel 31, and a nail-striking unit 42 that is movably connected to the swing arm unit 41.

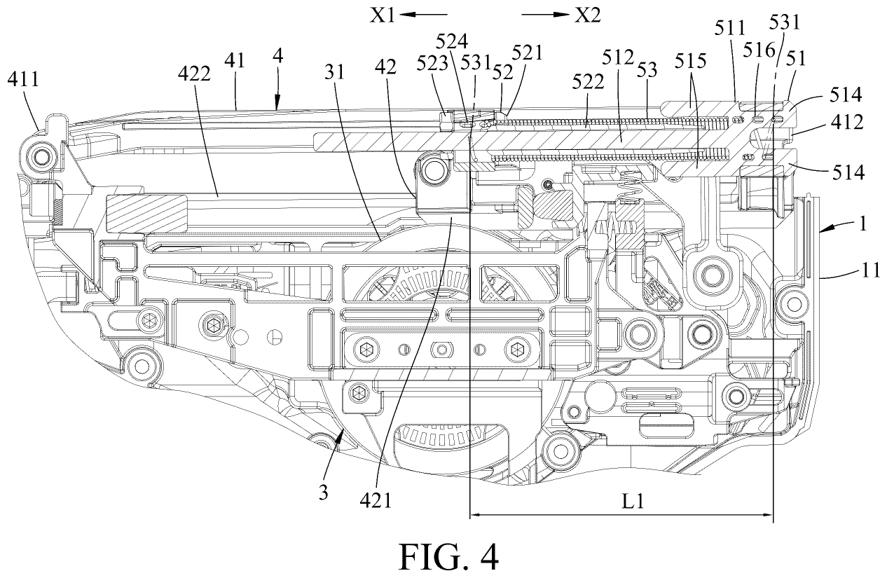

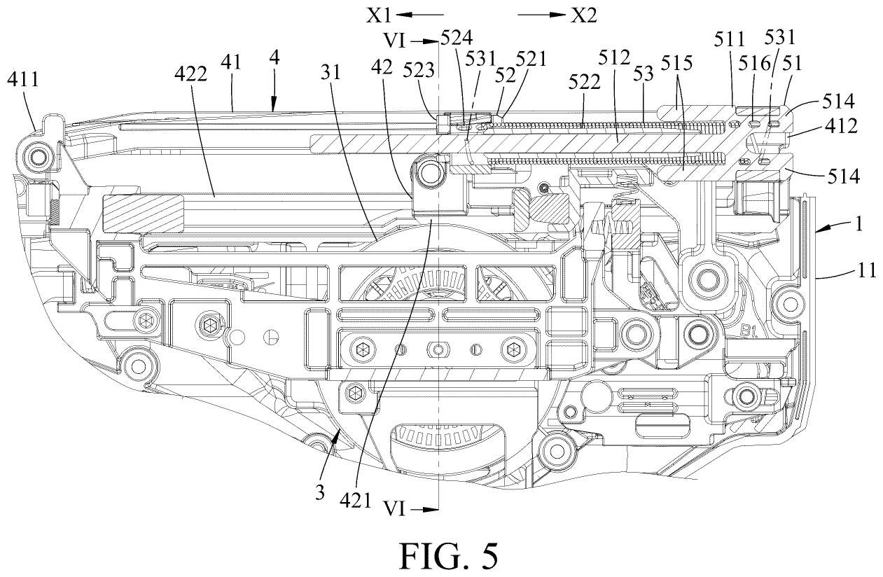

The swing arm unit 41 extends in a nail-striking direction (X1), and includes a pivot portion 411 that is pivotably connected to the main body portion 11, and a swing portion 412 opposite to the pivot portion 411. The swing arm unit 41 is pivotable between a normal position (see FIGS. 1 and 4) and a biased position (see FIG. 5). When the swing arm unit 41 is in the normal position, the swing arm unit 41 is distanced from the flywheel 31. When the swing arm unit 41 is in the biased position, the swing arm unit 41 is proximate to the flywheel 31. A distance between the swing arm unit 41 and the flywheel 31 when the swing arm unit 41 is in the normal position is greater than a distance between the swing arm unit 41 and the flywheel 31 when the swing arm unit 41 is in the biased position.

The nail-striking unit 42 includes an actuation member 421 that is operable for abutting against the flywheel 31, a nail-striking member 422 that is connected to the actuation member 421 and that extends into the barrel 12, and two engagement seats 423 that are spaced apart from each other in a widthwise direction (Y) perpendicular to the nail-striking direction (X1) and that are respectively connected to two opposite sides of the actuation member 421. Each of the engagement seats 423 has an engagement slot 424.

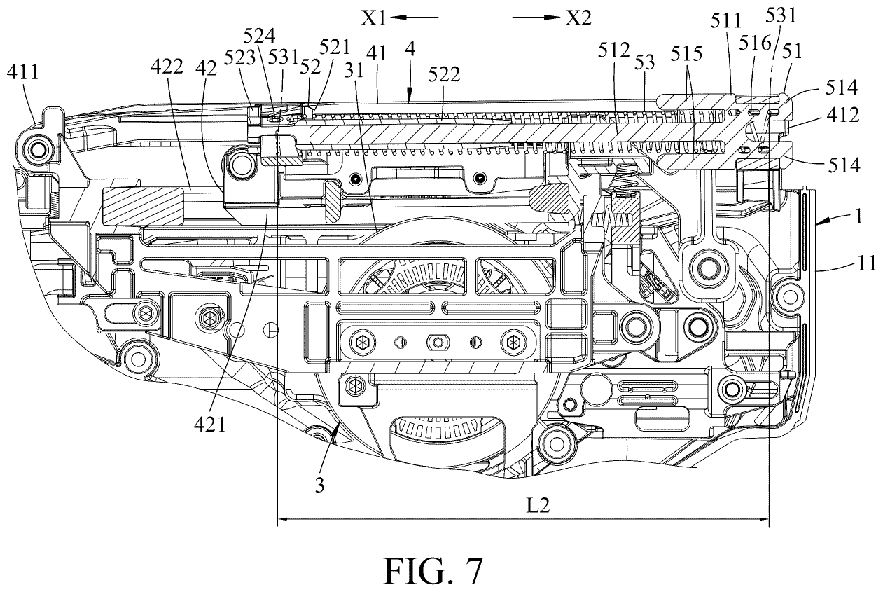

Referring to FIGS. 4 to 7, the nail-striking unit 42 is movable in the nail-striking direction (X1) from a pre-striking position (see FIG. 4) to a post-striking position (see FIG. 7) relative to the swing arm unit 41, and is movable in a retrieving direction (X2) opposite to the nail-striking direction (X1) from the post-striking position to the pre-striking position relative to the swing arm unit 41. When the swing arm unit 41 is in the normal position and the nail-striking unit 42 is in the pre-striking position, the actuation member 421 is proximate to the swing portion 412 and spaced apart from the flywheel 31. During pivot movement of the swing arm unit 41 from the normal position to the biased position, the nail-striking unit 42 is co-movable with the swing arm unit 41 toward the flywheel 31 until the nail-striking unit 42 abuts against the flywheel 31. When the swing arm unit 41 is in the biased position, and the nail-striking unit 42 is in the pre-striking position, the nail-striking member 422 abuts against the flywheel 31 to thereby be driven by the flywheel 31 to move, relative to the swing arm unit 41, to the post-striking position in the nail-striking direction (X1), so as to strike the nail in the barrel 12. When the nail-striking unit 42 is in the post-striking position, the nail-striking member 422 is proximate to the pivot portion 411 and away from the flywheel 31.

The retrieving device 5 includes two first position members 51, two second position members 52, and two resilient members 53. Each of the resilient members 53 interconnects a respective one of the first position members 51 and a respective one of the second position members 52. In other embodiments, a number of the first position member 51, a number of the second position member 52, and a number of the resilient member 53 may be one. Each of the second position members 52 is slidable in the nail-striking direction (X1) and the retrieving direction (X2) relative to a respective one of the first position members 51.

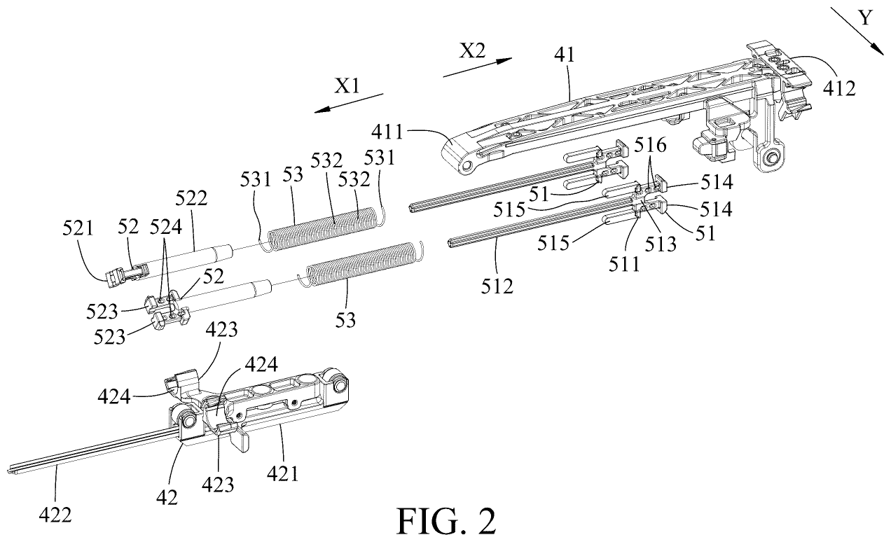

Each of the first position members 51 has a first clasp 511 that is removably engaged with the swing arm unit 41, and a slide rod 512 that extends from the first clasp 511 in the nail-striking direction (X1). For each of the first position members 51, the first clasp 511 has a base portion 513 (see FIG. 2) that is connected to the slide rod 512, two hook portions 514 that extend from the base portion 513 in the retrieving direction (X2) and that are spaced apart from each other, and two abutment portions 515 that extend from the base portion 513 in the nail-striking direction (X1) and that are spaced apart from each other. The hook portions 514 are removably engaged with the swing arm unit 41. Each of the hook portions 514 has a plurality of through holes 516 that are arranged in the retrieving direction (X2). For each of the first position members 51, the slide rod 512 has a cross-shaped cross section perpendicular to the nail-striking direction (X1).

Each of the second position members 52 extends through the engagement slot 424 of a respective one of the engagement seats 423 so as to be removably engaged with the respective one of the engagement seats 423. Each of the second position members 52 has a second clasp 521 that is removably engaged with the nail-striking unit 42, and a casing tube 522 that extends from the second clasp 521 in the retrieving direction (X2). The casing tubes 522 of the second position members 52 are respectively and slidably sleeved on the slide rods 512 of the first position members 51, such that each of the second position members 52 are slidable in the nail-striking direction (X1) and the retrieving direction (X2) relative to the respective one of the first position members 51. Each casing tube 522 is constantly in contact with the respective one of the slide rods 512 of the first position members 51. For each of the second position members 52, the second clasp 521 has two engagement portions 523 that extend from the casing tube 522 in the nail-striking direction (X1), and that are removably engaged with the engagement slot 424 of the respective one of the engagement seats 423. Each of the engagement portions 523 has a plurality of through holes 524 that are arranged in the nail-striking direction (X1).

Each of the resilient members 53 is disposed between the slide rod 512 of the respective one of the first position members 51 and the casing tube 522 of the respective one of the second position members 52. In this embodiment, each of the resilient members 53 is a spring. Each of the resilient members 53 has two resilient member ends 531 that are opposite to each other in the nail-striking direction (X1), and a plurality of coils 532. For each of the resilient members 53, a portion of the coils 532 that is adjacent to one of the resilient member ends 531 is engaged with the through holes 524 of the engagement portions 523 of the respective one of the second position members 52, and another portion of the coils 532 that is adjacent to another one of the resilient member ends 531 is engaged with the through holes 516 of the hook portions 514 and is positioned between the abutment portions 515 and the slide rod 512 of the respective one of the first position members 51.

Each of the resilient members 53 is operable for generating a resilient force to slide the respective one of the second position members 52 in the retrieving direction (X2) so as to retrieve the nail-striking unit 42 in the retrieving direction (X2). Each of the second position members 52 is slidable between a retracted position and an extended position relative to the respective one of the first position members 51. For each of the second position members 52, when the second position member 52 is in the retracted position, the second clasp 521 is proximate to the first clasp 511 of the respective one of the first position members 51, and the resilient member ends 531 of the respective one of the resilient members 53 are distanced from each other by a minimum distance (L1) in the nail-striking direction (X1). For each of the second position members 52, when the second position member 52 is in the extended position, the second clasp 521 is distal from the first clasp 511 of the respective one of the first position members 51, and the resilient member ends 531 of the respective one of the resilient members 53 are distanced from each other by a maximum distance (L2) in the nail-striking direction (X1). The maximum distance (L2) is greater than the minimum distance (L1).

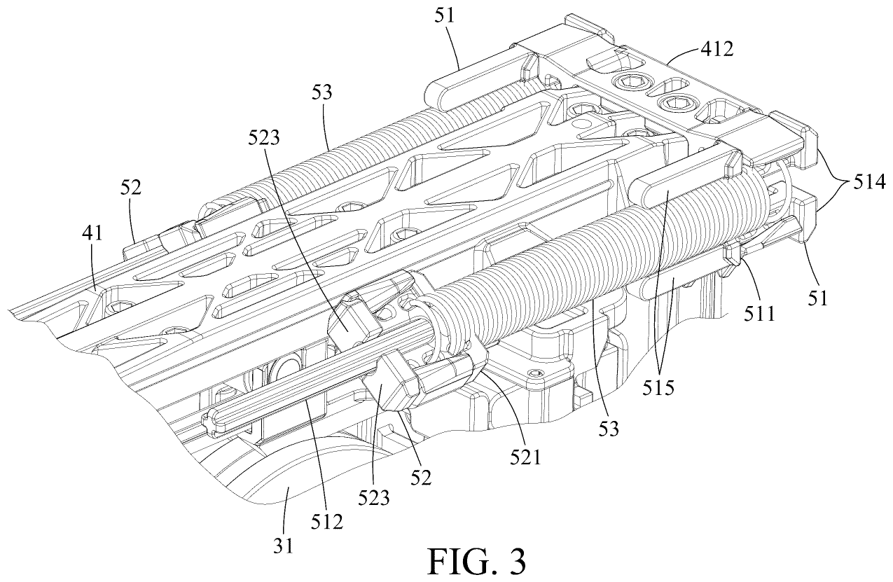

Referring to FIGS. 3 and 4, when the swing arm unit 41 is in the normal position and the nail-striking unit 42 is in the pre-striking position, the actuation member 421 is proximate to the swing portion 412 and spaced apart from the flywheel 31. At this time, the second position members 52 are in the retracted position, and each of the casing tubes 522 is in complete contact with the slide rod 512 of the respective one of the first position members 51.

Referring to FIGS. 1, 5, and 7, during movement of the swing arm unit 41 from the normal position to the biased position, the distance between the swing arm unit 41 and the flywheel 31 is shortened. At this time, each of the second position members 52 is in the retracted position, and the nail-striking unit 42 is at the pre-striking position. When the swing arm unit 41 is in the biased position, the actuation member 421 abuts against the flywheel 31, thereby being driven by the flywheel 31 to move to the post-striking position (see FIG. 7) in the nail-striking direction (X1) relative to the swing arm unit 41, so as to strike the nail in the barrel 12.

During movement of the nail-striking unit 42 from the pre-striking position to the post-striking position, the actuation member 421 drives the casing tubes 522 to slide respectively along the slide rods 512 in the nail-striking direction (X1). At this time, a distance between an end of each of the casing tubes 522 in the retrieving direction (X2) and an end of the respective one of the slide rods 512 in the nail-striking direction (X1) is inversely proportional to a distance the nail-striking unit 42 has moved in the nail-striking direction (X1) from the pre-striking position. At this time, a distance between the second clasp 521 of each of the second position members 52 and the first clasp 511 of the respective one of the first position members 51 is directly proportional to a distance the nail-striking unit 42 has moved in the nail-striking direction (X1) from the pre-striking position, and each of the casing tubes 522 is in contact with the respective one of the slide rods 512. Furthermore, at this time, each of the resilient members 53 is stretched and generates a resilient force that is stored therein.

When the nail-striking unit 42 is in the post-striking position, and after the nail has been struck by the nail-striking member 422, the swing arm unit 41 pivots to the normal position from the biased position, and the distance between the swing arm unit 41 and the flywheel 31 increases. At this time, the resilient force stored in the resilient members 53 moves the second position members 52 in the retrieving direction (X2) so as to retrieve the nail-striking unit 42 in the retrieving direction (X2).

Referring to FIGS. 4 and 7, during movement of the nail-striking unit 42 from the post-striking position to the pre-striking position, the actuation member 421 drives each of the casing tubes 522 to slide in the retrieving direction (X2) along the respective one of the slide rods 512. At this time, the distance between the end of each of the casing tubes 522 in the retrieving direction (X2) and the end of the respective one of the slide rods 512 in the nail-striking direction (X1) is directly proportional to a distance the nail-striking unit 42 has moved in the retrieving direction (X2) from the post-striking position. At this time, the distance between each of the second clasps 521 and the respective one of the first clasps 511 is inversely proportional to a distance the nail-striking unit 42 has moved in the retrieving direction (X2) from the post-striking position.

Referring to FIGS. 3 and 4, after the nail is struck, the swing arm unit 41 pivots back to the normal position, and the nail-striking unit 42 is moved back to the pre-striking position. At this time, each of the casing tubes 522 is once again in complete contact with the slide rod 512 of the respective one of the first position members 51.

It should be noted that, each of the second position members 52 is constantly in contact with the respective one of the first position members 51, and such contact will not be broken by the swing arm unit 41 moving between the normal position and the biased position and the nail-striking unit 42 moving between the pre-striking position and the post-striking position.

The advantages of the disclosure are as follows.

1. Since each of the second position members 52 is constantly in contact with the respective one of the first position members 51, and since each of the casing tubes 522 is sleeved on the respective one of the slide rods 512, when each of the resilient members 53 is stretched, the configuration of the first position members 51, the second position members 52, and the resilient members 53 limit movement of the resilient members 53, thereby preventing the resilient members 53 from swinging or bending, which improves stability and smoothness of a retrieval process of the nail-striking unit 42.

2. The retrieving device 5 is modulated, and the first clasps 511 and the second clasps 521 can be respectively engaged with or removed from the swing arm unit 41 and the nail-striking unit 42 without tools, allowing the retrieving device 5 to be mounted, maintained or replaced easily.

3. Since the slide rod 512 has a cross-shaped cross section perpendicular to the nail-striking direction (X1), there is a certain amount of friction between each of the casing tubes 522 and the respective one of the slide rods 512. The amount of friction is not enough to hinder movement of the nail-striking unit 42 in the nail-striking direction (X1), but is enough to stabilize movement of the second position members 52 when the nail-striking unit 42 is being retrieved, which prevents the nail-striking unit 42 from erroneously moving in the nail-striking direction (X1) and striking another nail.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A retrieving device adapted to be mounted to an electric nail gun, the electric nail gun including a gun body, a flywheel that is mounted in the gun body and that is driven rotatably by electrical energy, a swing arm unit that is mounted to the gun body and that is pivotable relative to the flywheel, and a nail-striking unit that is movably connected to the swing arm unit, the nail-striking unit being co-movable with the swing arm unit to abut against the flywheel during pivot movement of the swing arm unit, thereby being driven by the flywheel to move in a nail-striking direction relative to the swing arm unit, said retrieving device comprising:
at least one first position member that is adapted to be connected to the swing arm unit;
at least one second position member that is adapted to be connected to the nail-striking unit, that extends in a retrieving direction opposite to the nail-striking direction, that is sleeved on said at least one first position member, and that is slidable relative to said at least one first position member in the nail-striking direction and the retrieving direction, said at least one second position member being constantly in contact with said at least one first position member; and
at least one resilient member that interconnects said at least one first position member and said least one second position member, and that is operable for generating a resilient force to move said at least one second position member in the retrieving direction so as to retrieve the nail-striking unit in the retrieving direction.

2. The retrieving device as claimed in claim 1, wherein said at least one first position member has a first clasp that is adapted to be removably engaged with the swing arm unit, and a slide rod that extends from said first clasp in the nail-striking direction, said at least one second position member being slidably sleeved on said slide rod.

3. The retrieving device as claimed in claim 2, wherein said at least one second position member has a second clasp that is adapted to be removably engaged with the nail-striking unit, and a casing tube that extends from said second clasp in the retrieving direction, said casing tube being slidably sleeved on said slide rod.

4. The retrieving device as claimed in claim 3, wherein said first clasp has a base portion that is connected to said slide rod, and two hook portions that extend from said base portion in the retrieving direction and that are spaced apart from each other, said hook portions being adapted to be removably engaged with the swing arm unit.

5. The retrieving device as claimed in claim 4, wherein:
said first clasp further has two abutment portions that extend from said base portion in the nail-striking direction and that are spaced apart from each other, each of said hook portions having a plurality of through holes that are arranged in the retrieving direction; and
said at least one resilient member is disposed between said slide rod and said casing tube, and has a plurality of coils, a portion of said plurality of coils being engaged with said plurality of through holes of said hook portions and positioned between said abutment portions and said slide rod.

6. The retrieving device as claimed in claim 3, wherein:
said at least one resilient member has two resilient member ends that are opposite to each other in the nail-striking direction;
said at least one second position member is slidable between a retracted position and an extended position relative to said at least one first position member;
when said at least one second position member is in the retracted position, said second clasp is proximate to said first clasp, and said resilient member ends are distanced from each other by a minimum distance in the nail-striking direction; and
when said at least one second position member is in the extended position, said second clasp is distal from said first clasp, and said resilient member ends are distanced from each other by a maximum distance in the nail-striking direction, said maximum distance being greater than said minimum distance.

7. The retrieving device as claimed in claim 3, wherein:
said second clasp has two engagement portions that extend from said casing tube in the nail-striking direction, and that are adapted to be removably engaged with the nail-striking unit; and
each of said engagement portions has a plurality of through holes that are arranged in the nail-striking direction, said at least one resilient member being disposed between said slide rod and said casing tube, and having a plurality of coils, a portion of said plurality of coils being engaged with said plurality of through holes of said engagement portions.

8. The retrieving device as claimed in claim 3, wherein said slide rod has a cross-shaped cross section perpendicular to the nail-striking direction.

9. An electric nail gun comprising:
a gun body;
a flywheel that is mounted in said gun body and that is driven rotatably by electrical energy;
a swing arm unit that is mounted to said gun body and that is pivotable relative to said flywheel;
a nail-striking unit that is movably connected to said swing arm unit, said nail-striking unit being co-movable with said swing arm unit to abut against said flywheel during pivot movement of said swing arm unit, thereby being driven by said flywheel to move in a nail-striking direction relative to said swing arm unit; and
said retrieving device as claimed in claim 1, said retrieving device being connected to said swing arm unit and said nail-striking unit.

10. The electric nail gun as claimed in claim 9, wherein:
said at least one first position member includes two first position members;
said at least one second position member includes two second position members;
said at least one resilient member includes two resilient members; and
each of said resilient members interconnects a respective one of said first position members and a respective one of said second position members.

11. The electric nail gun as claimed in claim 10, wherein:
said nail-striking unit includes an actuation member that is operable for abutting against said flywheel, and two engagement seats that are spaced apart from each other in a widthwise direction perpendicular to the nail-striking direction and that are respectively connected to two opposite sides of said actuation member, each of said engagement seats having an engagement slot, each of said second position members extending through said engagement slot of a respective one of said engagement seats so as to be removably engaged with the respective one of said engagement seats.
